(19) United States
(12) Patent Application Publication
(10) Pub. No.: US 2003/0157822 A1
(43) Pub. Date: Aug. 21, 2003

(54) Modular ground bar system

(75) Inventors: Richard J. Green, Mississauga (CA); Patrick Wu, Scarborough (CA)

Correspondence Address: HARRINGTON & SMITH, LLP, 4 RESEARCH DRIVE, SHELTON, CT, 06484-6212, US

(73) Assignee: FCI AMERICAS TECHNOLOGY INC.

(21) Appl. No.: 10/370,911

(22) Filed: Feb. 20, 2003

(30) Foreign Application Priority Data
Feb. 21, 2002 (CA) 2,372,849

(51) Int. Cl. H01R 4/60

(52) U.S. Cl. 439/213

(57) ABSTRACT

A modular, electrically conductive bar system comprising of a plurality of elongate bars made of electrically conductive material. Each elongate bar has proximate and distal ends and a plurality of conductor attachment points. First and second mutually mating joining means are respectively provided on the proximate and distal ends of each elongate bar. In operation the proximate end of a first elongate bar can be connected to the distal end of another elongate bar through the corresponding first and second mutually mating means, and/or the distal end of the first elongate bar can be connected to the proximate end of another elongate bar through the corresponding first and second, mutually mating joining means.

### FIELD OF THE INVENTION

The present invention relates to an electrically conductive bar system, in particular but not exclusively for grounding applications.

### BACKGROUND OF THE INVENTION

Grounding terminal assemblies comprising a ground bar with a number of terminal frames into which conductor ends can be inserted and fastened have been proposed. Also known are grounding terminal components which can be grouped into various configurations to form grounding assemblies of different shapes and with different numbers of openings into which conductor ends can be individually inserted and fastened.

A variety of modular terminal blocks capable of interconnecting multiple pairs of individual conductors is also known in the art.

A first drawback of the existing grounding terminal assemblies is that the number of points where a conductor can be attached is limited by the length of the ground bar.

Another drawback of the existing grounding terminal assemblies is that they present a complex structure and include a large number of individual parts. Therefore, they also require a large number of fabrication and/or machining steps.

### SUMMARY OF THE INVENTION

The present invention overcomes the foregoing and other drawbacks by providing a modular, electrically conductive bar system comprising a plurality of elongate bars made of electrically conductive material and each having proximate and distal ends, and a plurality of conductor attachment points. First and second, mutually mating joining means are respectively provided on the proximate and distal ends of each elongate bar. In operation, the proximate end of a first elongate bar can be connected to the distal end of another elongate bar through the corresponding first and second, mutually mating joining means, and/or the distal end of the first elongate bar can be connected to the proximate end of another elongate bar through the corresponding first and second, mutually mating joining means.

To overcome the foregoing and other drawbacks of the prior art, the present invention also relates to an electrical bar system comprising:

an elongate bar made of electrically conductive, generally ductile material including a plurality of non-threaded holes; and

a plurality of self-tapping screws driven in respective non-threaded holes of the elongate bar for connecting conductors to the elongate bar.

The foregoing and other objects, advantages and features of the present invention will become more apparent upon reading of the following non restrictive description of embodiments thereof, given by way of example only with reference to the accompanying drawings.

### BRIEF DESCRIPTION OF THE DRAWINGS

In the appended drawings:

FIG. 1 is a top, perspective view of an elongate ground bar of a modular ground bar system in accordance with a first example of embodiment of the present invention;

FIG. 2 is an elevational side view of the elongated ground bar of FIG. 1;

FIG. 3 is a top plan view of the elongate ground bar of FIGS. 1 and 2;

FIG. 4 is a top perspective view of two elongated ground bars as illustrated in FIGS. 1-3 assembled end to end in the modular ground bar system in accordance with the first example of embodiment of the present invention;

FIG. 5 is a top perspective view of a first end bar of the modular ground bar system in accordance with the first example of embodiment of the present invention;

FIG. 6 is a top perspective view of a second end bar of the modular ground bar system in accordance with the first example of embodiment of the present invention; and

FIG. 7 is a top perspective view of an alternative standalone elongate bar in accordance with a second example of embodiment of the present invention.

### DETAILED DESCRIPTION OF THE EMBODIMENTS

In the following description, the present invention will be described in relation to a modular ground bar system. However, it should be kept in mind that the present invention also emcompasses applications of the modular bar system other than grounding applications.

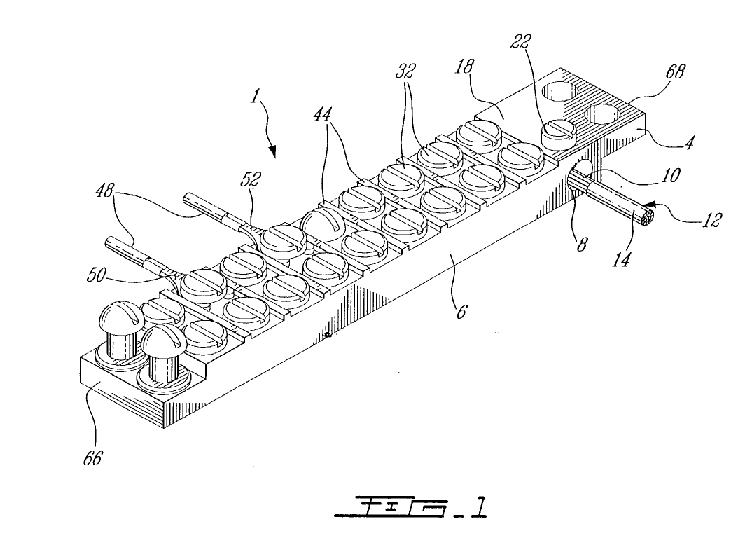

Referring now to FIG. 1, an elongate ground bar 2 is illustrated. Elongate bar 1 is made of electrically conductive, generally ductile material, for example a metallic material such as aluminium, copper or brass.

To provide enhanced resistance to corrosion and oxidation while maintaining conductive properties following machining the outer surface of the elongate bar 2 is plated with an electrically conductive protective coating 4. As a non limitative example, the protective coating 4 is deposited on the outer surface of the elongate bar 2 by means of well known anodising or electroplating techniques.

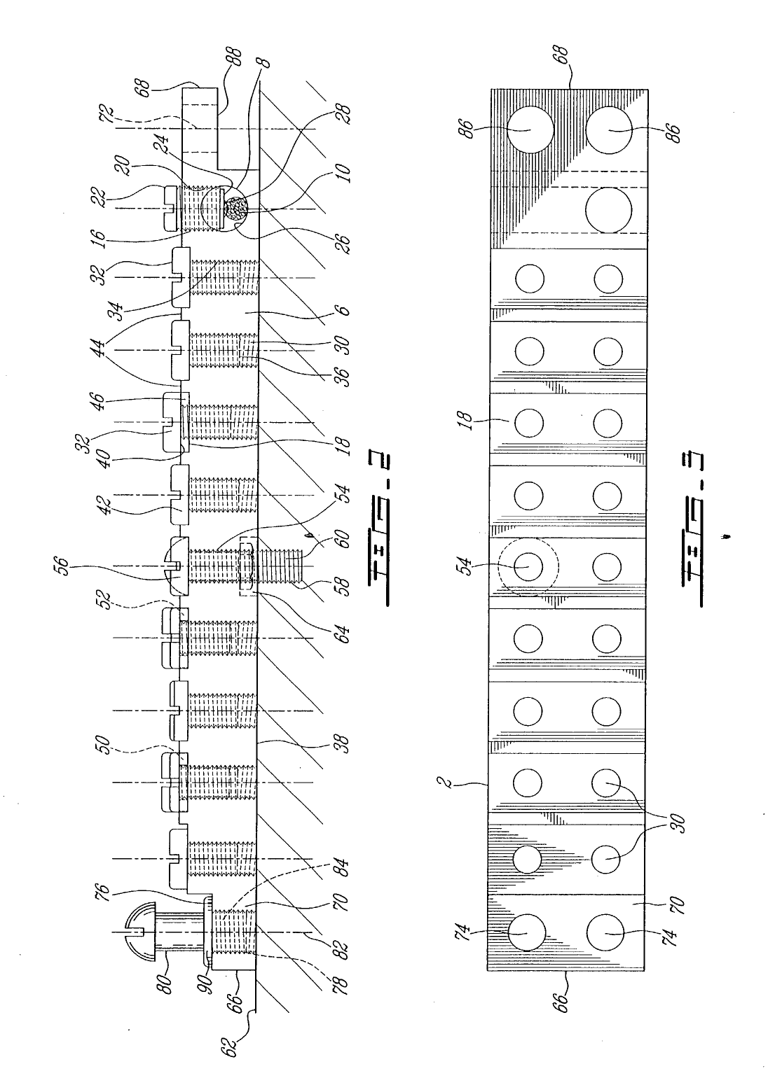

Referring now both to FIGS. 1 and 2, a conductor-receiving hole 8 is machined, for example drilled into a side face 6 of the elongated bar 2. The exposed end 10 of an insulated conductor, for example an insulated cable 12 from which the insulation 14 has been removed can be inserted in this conductor-receiving hole 8. As a non limitative example, the cable 12 can be stranded and of a relatively heavy gauge.

A set screw receiving hole 16 which intersects with the conductor-receiving hole 8 is machined, for example drilled in the top face 18 of the elongate bar 2. In the illustrated embodiment, the hole 16 has a diameter which is substantially the same as that of the hole 8. Also, the inner surface 20 of the hole 16 can be threaded. A threaded set screw 22, preferably made of an electrically conductive material, is inserted into the threaded hole 16 to move toward the conductor-receiving hole 8. Alternatively, hole 16 is not threaded and set screw 22 is a self-tapping set screw.

Upon tightening of the set screw 22 the exposed end 10 of the cable 12 is sandwiched between the lower end 24 of the set screw 22 and the inner wall 26 of the conductor-receiving hole 8, thereby retaining the exposed end 10 of the cable 12 in place and providing improved electrical conductivity between the elongate bar 2 and the cable 12. For example, the lower end 24 of the set screw 22 is formed with a raised nipple 28 to improve the distribution of the exposed end 10 of the cable 12 along the inner wall 26 of the conductor-receiving hole 8 thereby further improving electrical contact between the inner wall 26 of the conductor-receiving hole 8 and the exposed end 10 of the cable 12.

A series of regularly spaced apart holes 30 are machined, for example drilled through the elongate bar 2 perpendicular to the top face 18. The holes 30 can be non-threaded holes suitably dimensioned to receive respective self-tapping terminal connection screw such as 32. Ductility of the material forming the elongate bar 2 enables the use of screws 32 self-tapping in the inner surfaces 34 of the holes 30. Alternatively, the holes 30 can be threaded to receive the screws 32. The length of the screws 32 is so selected that the lower end 36 of each screw 32 does not extend beyond the bottom face 38 of the elongate bar 2 when the underside 40 of the head member 42 of the screw 32 is tightened against the top face 18 of the elongate bar 2.

In the example of FIG. 1, the screws 32 are arranged along bar 2 in two parallel rows. Also, the rows define along bar 2 pairs of laterally adjacent screws.

A series of parallel, transversal ridges such as 44 are formed on the top face 18 of the elongate bar 2. The ridges 44 are spaced apart at regular intervals and are disposed between the successive pairs of laterally adjacent screws 32 to define conductor attachment regions such as 46 between the underside 40 of the head members 42 of the screws 32 and the top face 18 of the elongate bar 2. The spacing between to successive ridges 44 is selected such that the head members 42 of the terminal connection screws 32 fit snugly there between.

Insulated wires such as 48 having a suitably stripped end 50 or, alternatively, a spade terminal 52 or ring terminal (not shown) are inserted into a conductor attachment region 46. The corresponding screw 32 is then tightened to thereby clamp the stripped end 50, spade terminal 52 or ring terminal (not shown) between the underside 40 of the head member 42 of this screw 32 and the top face 18 of the elongate bar 2. The snug fit between the head members 42 of the terminal connection screws 32 and the ridges 44 prevents the stripped conductor ends such as 50 from being ejected from the conductor attachment region 46 during tightening of the screws 32, thus improving the robustness of the interconnection and the quality of the contact between the wire 48 and the elongated bar 2.

Additionally, the ridges 44 facilitate the insertion of a spade terminal 52 or ring terminal (not shown) and prevent the spade terminal 52 or ring terminal (not shown) from rotating, both during tightening of the corresponding screw 32 and during day-to-day operation, which might accidentally loosen the terminal connection screw 32.

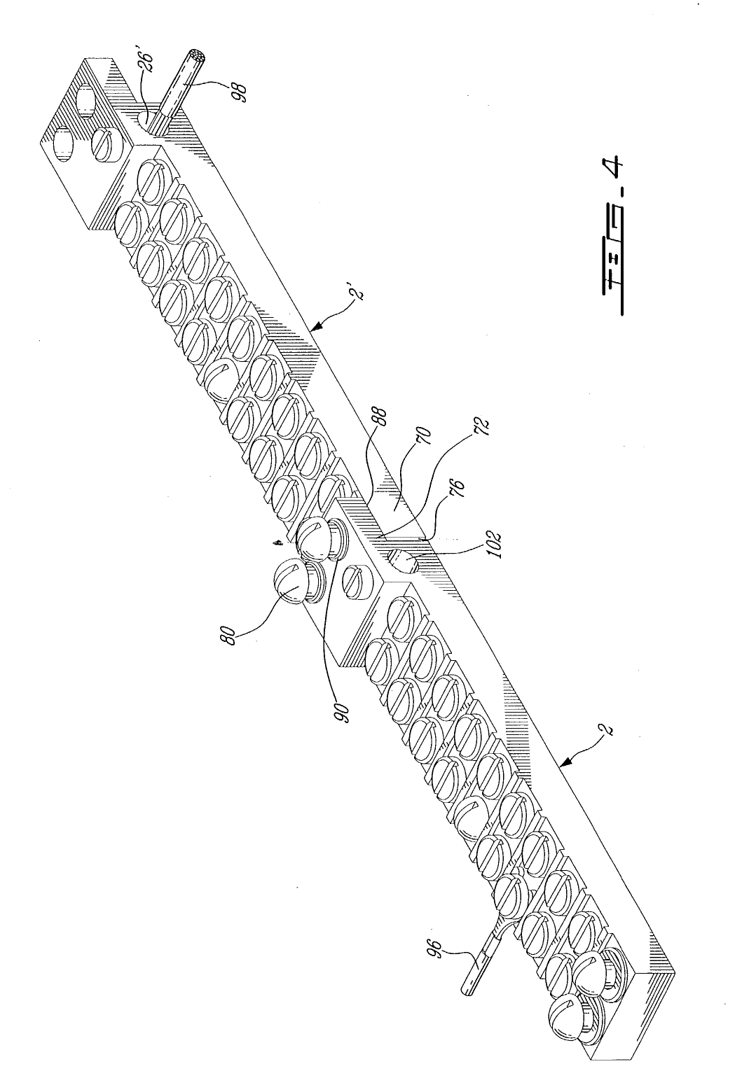

Referring now to FIG. 3, an anchor assembly comprises a non-threaded anchoring hole 54 of slightly larger diameter machined, for example drilled through the elongated bar 2 perpendicular to top face 18. In the example of FIG. 3, the hole 54 replaced one of the holes 30 in one of the two rows of such holes 30. The anchoring hole 54 is also preferably located towards the middle of the length of the elongate bar 2. Also, the bottom face of the 38 of the elongate bar 2 is provided with an annular cavity 64 around the anchoring hole 54

Referring now to FIGS. 1-3, the anchor assembly further comprises an anchoring screw 56 in the anchoring hole 54, with the head of the screw 56 resting on the top face 18 of the elongate bar 2. The lower end 58 of the anchoring screw 56 extends below the bottom face 38 of the elongate bar 2. Since the diameter of the anchoring hole 54 is dimensioned to enable free movement of the screw 56 within the hole 54 a retaining ring is mounted on the screw 56 in the annular cavity 64 to retain the anchoring screw 56 onto the elongate bar 2. Additionally, at least the lower end 58 of the anchoring screw 56 is threaded for screwing into a hole, threaded or not, of any support structure schematically illustrated at 62 to thereby anchor the elongate bar 2 on this support structure 62.

First and second mutually mating joining means are respectively provided on the proximate and distal ends of the elongate bar 2.

Referring to FIGS. 2 and 3, to form the first joining means, the proximate end 66 of the elongate bar 2 is machined to provide a raised overlapping lip 72 having a pair of screw-receiving holes 86 perpendicular to the lower face 88 of lip 72.

Still referring to FIGS. 2 and 3, to form the second joining means, the distal end 68 of the elongate bar 2 is machined to provide a joining seat 70. Holes such as 74 are made in the joining seat 70 perpendicular to an upper face 76 of the joining seat 70. According to a non limitative example, the inner surfaces 78 of the holes 74 are threaded for accepting a pair of bar joining screws such as 80.

At least the lower ends 82 of the joining screws 80 are threaded for being screwed into the holes 74. Also, the diameter of the holes 86 is selected such that the pair of joining screws 80 fit snugly therein, but are free to move within these holes 86. A washer such as 90 (FIG. 2) is provided for each of the joining screws 80. The length of the joining screws 80 is selected such that when elongated bars 2 joined end to end and the joining screws 80 are fully tightened, the lower ends 82 of the joining screws 80 do not project beyond the bottom face 38 of the elongate bar 2.

Referring now to FIG. 4, in order to assemble end to end two elongate bars such as 2 and 2′, the lower face 88 of the raised overlapping lip 72 at the proximate end of elongate bar 2 is positioned over the upper face 76 of the joining seat 70 at the distal end of elongate bar 2′. Washers 90 are mounted on the joining screws 80 which are then inserted through the holes 86 and screwed into the threaded holes 74. The joining screws 80 are then tightened bringing the lower face 88 of the overlapping lip 72 into contact with the upper face 76 of the joining seat 70.

By tightening the joining screws 80 a high quality contact is established via the lower face 88 of the overlapping lip 72 and the upper face 76 of the joining seat 70 and therefore, for example, between a wire 96 attached to the elongate bar 2 and a cable 98 inserted in the ground conductor-receiving hole 26′ of the elongate bar 2′. This provides, amongst other benefits, for increased robustness in the case of failure of, for example, a conductor cable (not shown) inserted in the conductor-receiving hole 26 of the elongate bar 2 or the use of a single cable in lower current applications. As will be apparent to those of ordinary skill in the art a virtually unlimited number of elongate bars such as 2 can be joined end to end via the mutually mating joining means to form a single ground bar system suited to a given application.

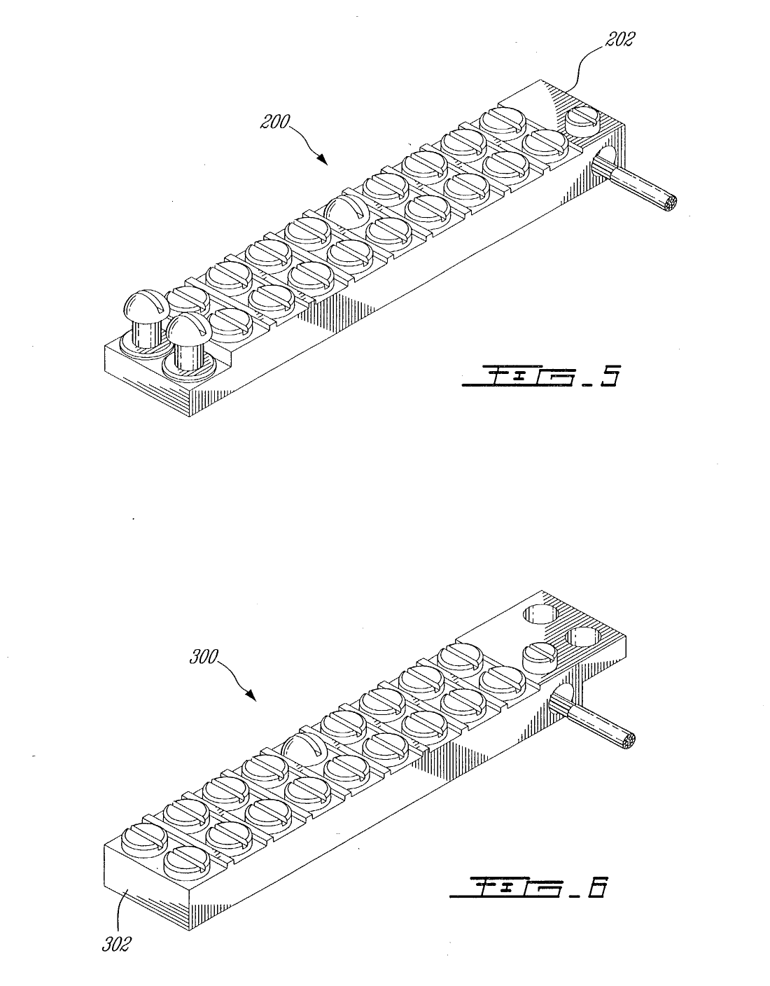

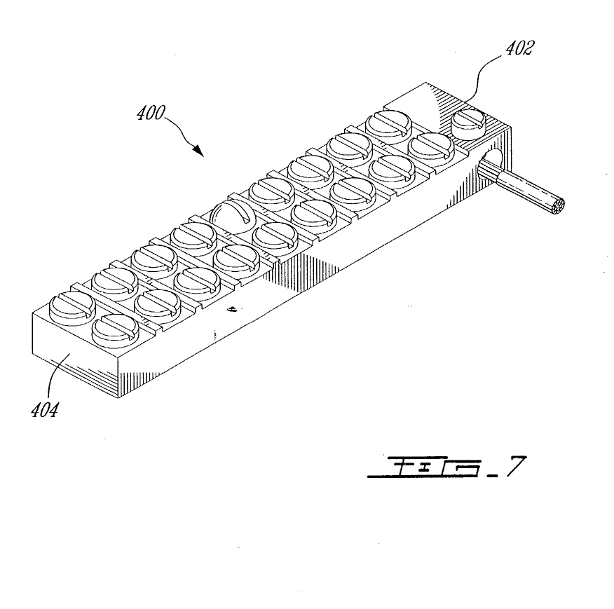

Referring now to FIGS. 5 and 6, examples of elongate bars for terminating a ground bar system will be described.

FIG. 5 illustrates a terminating elongate bar 200. The terminating bar 200 retains most of the characteristics of the elongate bar 2 as described with reference to FIGS. 1-3 with the exception that the raised overlapping lip, referred to as 72 in FIG. 1, is absent from the proximate end 202 of the elongate bar 200. It will be apparent to those of ordinary skill in the art that the terminating bar 200 has a distal end provided with a joining seat and is therefore adapted for connection to the raised overlapping lip of the proximate end of an elongate bar 2 as as described with reference to FIGS. 1-3.

Similarly, FIG. 6 discloses a terminating elongate bar 300. Again, the terminating bar 300 retains most of the characteristics of the elongate bar 2 as described with reference to FIGS. 1-3 with the exception that the joining seat, referred to as 70 in FIG. 1, is absent from the distal end 302 of the terminating bar 300. It will also be apparent to those of ordinary skill in the art that the terminating elongate bar 300 has a proximate end provided with a raised overlapping lip and is therefore adapted for connection to the joining seat at the distal end of an elongate bar 2 as described with reference to FIGS. 1-3.

FIG. 7 illustrates an example of standalone elongate ground bar 400 which retains most of the characteristics of the elongate bar 2 as described with reference to FIGS. 1-3 with the exception that:

the overlapping lip, referred to as 72 in FIG. 1, is absent from the proximate end 402 of the standalone bus bar 400; and

the joining seat, referred to as 70 in FIG. 1, is absent from the distal end 404 of the standalone bus bar 400.

It will be apparent to those of ordinary skill in the art that the standalone bus bar 400 is adapted for standalone operation.

Although the present invention has been described hereinabove by way of embodiments thereof, these embodiments can be modified at will, within the scope of the appended claims, without departing from the spirit and nature of the subject invention.

The embodiments of the invention in which an exclusive property or privilege is claimed are defined as follow:

1. A modular, electrically conductive bar system comprising:
a plurality of elongate bars made of electrically conductive material and each having:
proximate and distal ends; and
a plurality of conductor attachment points; and
first and second, mutually mating joining means respectively provided on the proximate and distal ends of each elongate bar;
whereby, in operation, the proximate end of a first elongate bar can be connected to the distal end of another elongate bar through the corresponding first and second, mutually mating joining means, and/or the distal end of the first elongate bar can be connected to the proximate end of another elongate bar through the corresponding first and second, mutually mating joining means.

2. A modular, electrically conductive bar system as defined in claim 1, further comprising at least one anchor assembly to be interposed between one of the elongate bar and a support structure.

3. A modular, electrically conductive bar system as defined in claim 1, wherein:
said elongate bars each comprises a top face and a side face;
said conductor attachment points of at least one elongate bar comprise a main conductor attachment point;
said main conductor attachment point comprises a conductor-receiving hole in the side face of said at least one elongate bar and a set screw receiving hole made in the top face of said at least one elongate bar and intersecting said conductor-receiving hole, and a set screw driven in the set screw receiving hole for clamping a conductor inserted into said conductor-receiving hole.

4. A modular, electrically conductive bar system as defined in claim 1, wherein the set screw receiving hole and the conductor-receiving hole have a same diameter.

5. A modular, electrically conductive bar system as defined in claim 1, wherein at least a part of said conductor attachment points each comprise a non-threaded hole in the elongate bar and a self-tapping screw driven in said non-threaded hole and having a head portion.

6. A modular, electrically conductive bar system as defined in claim 1, wherein said conductor attachment points are equally spaced apart and arranged in rows.

7. A modular, electrically conductive bar system as defined in claim 1, further comprising a series of substantially parallel transversal ridges distributed between said conductor attachment points to define conductor attachment regions.

8. A modular, electrically conductive bar system as defined in claim 2, wherein said at least one anchor assembly comprises a hole in one of said elongate bars and, associated to said hole, a bolt-and-nut assembly.

9. A modular, electrically conductive bar system as defined in claim 1, wherein:
said first joining means comprises:
a raised overlapping lip at the proximate end of the elongate bar, said raised overlapping lip having at least one screw-receiving hole; and
said second joining means comprises:
a joining seat at the distal end of the elongate bar, said joining seat having at least one screw-engaging hole; and
at least one joining screw;
wherein, in operation, the raised overlapping lip at the proximate end of one elongate bar overlaps the joining seat at the distal end of another elongate bar, and said at least one joining screw is inserted through said at least one screw-receiving hole and driven in said at least one screwengaging hole.

10. An electrical bar system comprising:
an elongate bar made of electrically conductive, generally ductile material including a plurality of non-threaded holes; and
a plurality of self-tapping screws driven in respective non-threaded holes of the elongate bar for connecting conductors to said elongate bar.

11. An electrical bar system as defined in claim 10, wherein:
the elongate bar has a rectangular cross section, first and second opposite faces, and a given thickness between said first and second faces; and
the non-threaded holes extend through the thickness of said elongate bar from the first face to the second face; and
the self-tapping screws are driven through respective non-threaded holes through one of the first and second faces.

12. An electrical bar system as defined in claim 11, wherein one of said non-threaded holes is used to attach the elongate bar member to a support structure by means of a fastener extending through said one non-threaded hole.
